(19) United States
(12) Patent Application Publication
(10) Pub. No.: US 2005/0154606 A1
(43) Pub. Date: Jul. 14, 2005

(54) User interface for displaying organization structure

(76) Inventors: Orestis Terzidis, Schwetzingen (DE); Martin Rogge, Ostringen-Tiefenbach (DE); Heike Berger, Oberhausen-Rheinhausen (DE); Hendrik Geipel, Walldorf (DE); Mathias Schoenecker, Hambrucken (DE); Joachim Puteick, Ubstadt-Weiher (DE); Martin Zielonkowski, Freinsheim (DE)

Correspondence Address: FISH & RICHARDSON, P.C., PO BOX 1022, MINNEAPOLIS, MN, 55440-1022, US

(21) Appl. No.: 10/895,365

(22) Filed: Jul. 21, 2004

Related U.S. Application Data
(60) Provisional application No. 60/535,539, filed on Jan. 12, 2004.

(51) Int. Cl. G06F 17/60; G06F 17/00; G06F 9/00; G06F 3/00

(52) U.S. Cl. 705/1; 715/962; 715/767

(57) ABSTRACT

A graphical user interface displays organizational structure information associated with a business organization having multiple organizational units on a display device of a computer. The graphical user interface includes structural unit indicators and connectors. Each structural unit indicator represents a structural unit of the business organization and includes one or more business character indicators. Each business character indicator represents one of multiple business characters. Each connector is associated with two and only two structural unit indicators and represents a hierarchical relationship between the two structural unit indicators. One of the structural unit indicators corresponds to a subordinate structural unit and another of the structural unit indicators corresponds to a superordinate structural unit. A display position of each type of the business character indicator is substantially the same display position relative to a shape of the structural unit indicators and to others of the multiple business characters.

### CROSS REFERENCE TO RELATED APPLICATIONS

This application claims the benefit of U.S. Provisional Application No. 60/535,539, filed Jan. 12, 2004, and titled “Organization Management,” which is incorporated by reference in its entirety.

### TECHNICAL FIELD

This description relates to a user interface and data structure for use in specifying and displaying information describing hierarchical structures of organizations.

### BACKGROUND

Organizations, such as business entities, government entities and non-profit organizations, typically are organized into structural components that represent the internal structure of the organization. The structural components of an organization, particularly a large organization, may be organized into one or more hierarchies. A computer system may be used to represent and display the structure of an organization.

### SUMMARY

The invention provides a graphical display of the organizational structure of a business entity that, at a glance, makes visible the characteristics of each of the displayed structural units. In some cases, the graphical display may show all of the structural units of the business entity. In the case of a large business entity having many structural units, the display may show only a portion of the structural units for the business entity and the portion that is displayed may be selected by a user. The graphical display represents each structural unit as a graphical shape. For each structural unit displayed, the graphical display identifies the business characters applicable to the structural unit. A business character identifies a characteristic, attribute or property of the structural unit or a function performed by the structural unit. Business characters are classified into groups, which may be referred to as business character groups. The graphical display also includes an indication of hierarchical relationships between the displayed structural units. Multiple hierarchies of structural units may be displayed. Similar structural units that are not directly related by hierarchical relationships may be grouped together, and the group of similar structural units may be called an area. In addition, the graphical display also may include positions that are associated with a structural unit.

The graphical display of structural units is created from information stored in a data structure that describes the structural units of the organization. The information may be referred to as an organization management model or, more simply, an org model. The data structure includes, for each structural unit of the organization, information describing the business characters of the structural unit, the relationships involving the structural unit, and, optionally, positions that may be filled by employees or agents of the organization and are associated with the structural unit. The business characters are classified into groups.

In some implementations, the organization information may be accessible to multiple business application programs. This may help reduce the amount of redundant or inconsistent organizational management data that is stored and maintained for multiple application programs. Additionally or alternatively, the organization information and graphical user interface may be a stand-alone visualization tool for displaying the structure of an organization.

In one general aspect, a graphical user interface displays organizational structure information associated with a business organization having multiple organizational units on a display device of a computer. The graphical user interface includes structural unit indicators and connectors. Each structural unit indicator represents a structural unit of the business organization and includes one or more business character indicators. Each business character indicator represents one of multiple business characters. Each connector is associated with two and only two structural unit indicators and represents a hierarchical relationship between the two structural unit indicators. One of the structural unit indicators corresponds to a subordinate structural unit and another of the structural unit indicators corresponds to a superordinate structural unit. A display position of each type of the business character indicator is substantially the same display position relative to a shape of the structural unit indicators and to others of the multiple business characters.

Implementations may include one or more of the following features. For example, at least one of the structural unit indicators may include one or more position indicators. Each position indicator may identify a position that is associated with the structural unit represented by the structural unit indicator.

A display attribute of each business character indicator of a particular business character may be substantially the same as display attributes of other business character indicators of the particular business character. The display attribute may include one or more of a shape, a color, or a type of shading.

A display attribute of each business character indicator of a particular business character may indicate an association of the particular business character with a business character group. The display attribute may include one or more of a shape, a color, or a type of shading.

A business character indicator may represent one of the business characters company, company group, segment, profit center, cost center, inventory location, production location, ship-from location, ship-to location, target-of-supply, source-of-supply, purchasing, service, and sales.

At least one of the structural unit indicators may include an indicator of a business character group that is associated with the structural unit represented by the at least one structural unit indicator and is associated with one or more business characters represented by business character indicators included in the at least one structural unit indicator. A display attribute of the indicator of the business character group may be substantially the same as a display attribute of the one or more business character indicators associated with the indicator of the business character group.

Each of the structural unit indicators may include an indicator of a business character group that is associated with the structural unit represented by the structural unit indicator and is associated with one or more business characters represented by business character indicators included in the structural unit indicator. A display attribute of the indicator of the business character group may be substantially the same as a display attribute of the one or more business character indicators associated with the indicator of the business character group.

The organizational structure information may include external structural unit indicators and external connectors. Each external structural unit indicator may represent a structural unit external to the business organization that is included in an extended enterprise of the business organization. Each external structural unit indicator also may include one or more business character indicators associated with the external structural unit. Each connector may be associated with at least one graphical external structural unit indicators and may represent a hierarchical relationship between the at least one external structural unit indicator and a structural unit indicator or between two external structural unit indicators. One of the structural unit indicators may correspond to a subordinate structural unit and another of the structural unit indicator may correspond to a superordinate structural unit. The display position of each of the business character indicators may be substantially the same display position relative to a shape of the structural unit indicator.

Implementations of the techniques discussed above may include a method or process, a system or apparatus, computer software on a computer-accessible medium, or a graphical user interface.

A graphical display for presenting the structure of an organization may be useful, particularly in an organization with a large number of structural units. Through the use of the graphical display, a user may be able to more quickly comprehend the organizational structure of a business enterprise. This may be particularly true when multiple hierarchies are displayed on the graphical display.

The details of one or more of the implementations are set forth in the accompanying drawings and description below. Other features will be apparent from the description and drawings, and from the claims.

### DESCRIPTION OF DRAWINGS

FIG. 1 is a block diagram of a system for specifying and displaying information describing the hierarchical structure of an organization in accordance with the invention.

FIGS. 2A and 2B are illustrations of a graphical structural unit indicator representing one of the structural units included in an organization.

FIGS. 3A and 3B are diagrams of a hierarchy of graphical structural unit indicators of FIG. 2A.

FIG. 4 is a block diagram of an example data structure for use in specifying and displaying the hierarchy of FIG. 3A.

FIGS. 5, 6A, 6B, and 6C are representations of example organization hierarchy information stored in the data structure of FIG. 4.

FIG. 7 is a flow chart of a process for displaying the graphical structural unit indicator of FIG. 2A.

FIG. 8 is a flow chart of a process for displaying the hierarchy of graphical structural unit indicators of FIG. 3A.

FIG. 9 is a flow chart of a process for specifying the details of a structural unit.

### DETAILED DESCRIPTION

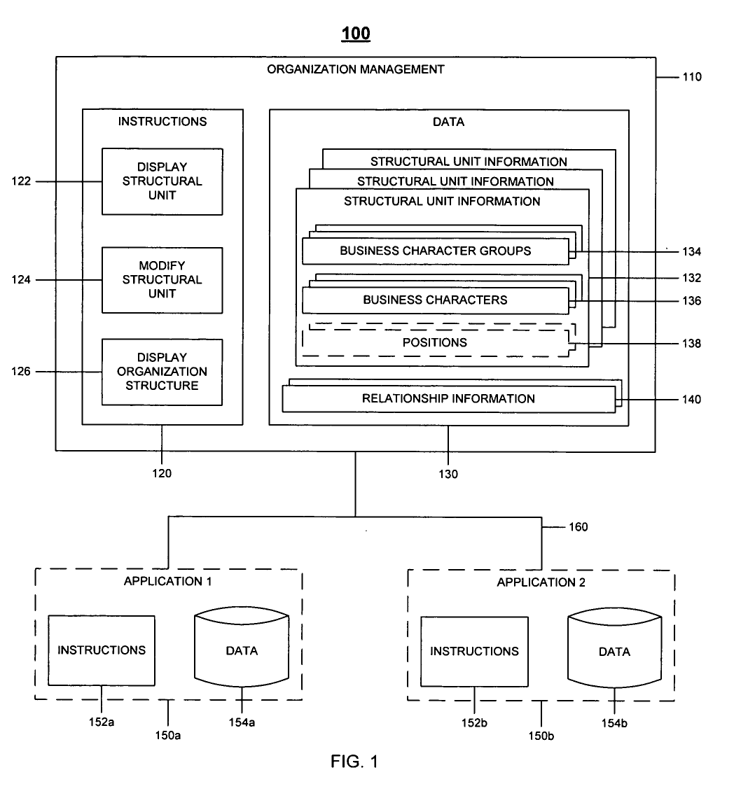

FIG. 1 is a block diagram of a system 100 for specifying and displaying information describing the hierarchical structure of an organization. The organization includes multiple structural units, each of which as a particular function within the organization. The relationships between the structural units define the structure of the organization. The system 100 includes an organization management application 110 that includes instructions 120 for specifying and displaying the organizational structure. More particularly, the instructions 120 include an instruction set 122 for displaying a single structural unit, an instruction set 124 for modifying a structural unit, and an instruction set 126 for displaying the entire organizational structure or a portion thereof.

The organization management application 110 also includes a data store 130 that defines the structure of the organization. More specifically, the data store 130 includes multiple structural unit data structures 132. Each of the structural unit data structures 132 includes multiple business character group data structures 134, business character data structures 136, and, optionally, position data structures 138. The data store 130 also includes relationship data structures 140 in which the relationships between the structural units defined by the structural unit data structures 132 are specified.

Each of the structural unit data structures 132 represents a structural unit of the organization whose structural information is specified and displayed by the organization management application 110. The structural units are the basic structural components of the organization. Each structural unit may represent an extended enterprise that is involved in work and business processes performed by structural units, even if all of the structural units do not belong to the same legal entity. The information stored within each structural unit data structure 132 describes the characteristics of the corresponding structural unit within the organization. For example, each of the structural units may be described by the business characters of the structural unit. Each of the business characters describes a characteristic attribute or property of the corresponding structural unit or a function performed by the corresponding structural unit. Each structural unit data structure 132 includes business character data structures 136 that represent the business characters of the corresponding structural unit. For example, a structural unit may be a cost center, a profit center, or an inventory location, each of which are examples of business characters that may be represented by a business character data structure 136 included in the corresponding structural unit information 132. Each structural unit data structure 132 often includes multiple business character data structures 136.

The business characters of a structural unit may be separated into one or more business character groups, and each business character may be associated with a specific business character group. For example, some or all of the business characters may be related to the legal aspects of the structural unit, the financial aspects of the structural unit, the location of the structural unit, the personnel of the structural unit, or the work performed at the structural unit, each of which is a business character group that may be associated with a structural unit. The structural unit data structure 132 includes one or more business character group data structures 134, and each of the business character data structures 136 included in the structural unit data structure 132 is associated with one of the business character group data structures 134 to represent the categorization of the corresponding business characters into business character groups.

Each structural unit also may be related to one or more positions. The positions may represent planned or existing employees or agents that are assigned to the structural unit. Each position has a defined relationship with the corresponding structural unit. For example, an employee having a position may “work for” the structural unit, in which case, the position may be said to be in a “works for” or “assignment” relationship with the structural unit. As another example, an employee having a position may “report to” the manager, or some other position, of the structural unit, in which case the position may be said to be in a “report to” relationship with another position of the structural unit. The structural unit data structure 132 includes one or more optional position data structures 138 to represent the relationship between the corresponding positions and the structural unit. The position data structures 138 may be related to one another to represent “report to” relationships between the corresponding data structures.

Relationships exist between pairs of the structural units included in the organization, and the relationship data structures 140 models each of the relationships between the pairs of structural units. Each relationship data structure 140 identifies the structural unit data structures 132 corresponding to the two related structural units, as well as the type of relationship between the identified structural units. Examples of types of relationships between the structural units corresponding to the identified structural unit data structures 132 include, for example, a legal relationship, a financial relationship, a working relationship, a personnel relationship, or a relationship in the geographic location of the structural units. The structural units also may be related by a standard or default relationship in which the details of the relationship are not specified. One example of a default relationship may be a hierarchical relationship, where one structural unit is subordinate to the other structural unit in the hierarchy of the organization that includes the two structural units.

The information stored within the data store 130 is manipulated by the instructions 120. More specifically, the instruction set 122 for displaying a single structural unit accesses a structural unit data structure 132 and displays the information included in the structural unit data structure 132. The structural unit is displayed as a graphical structural unit indicator. The structural unit indicator may include an indication of the business characters of the structural unit and the business character groups to which the business characters belong. The structural unit indicator also includes an indication of the positions related to the structural unit.

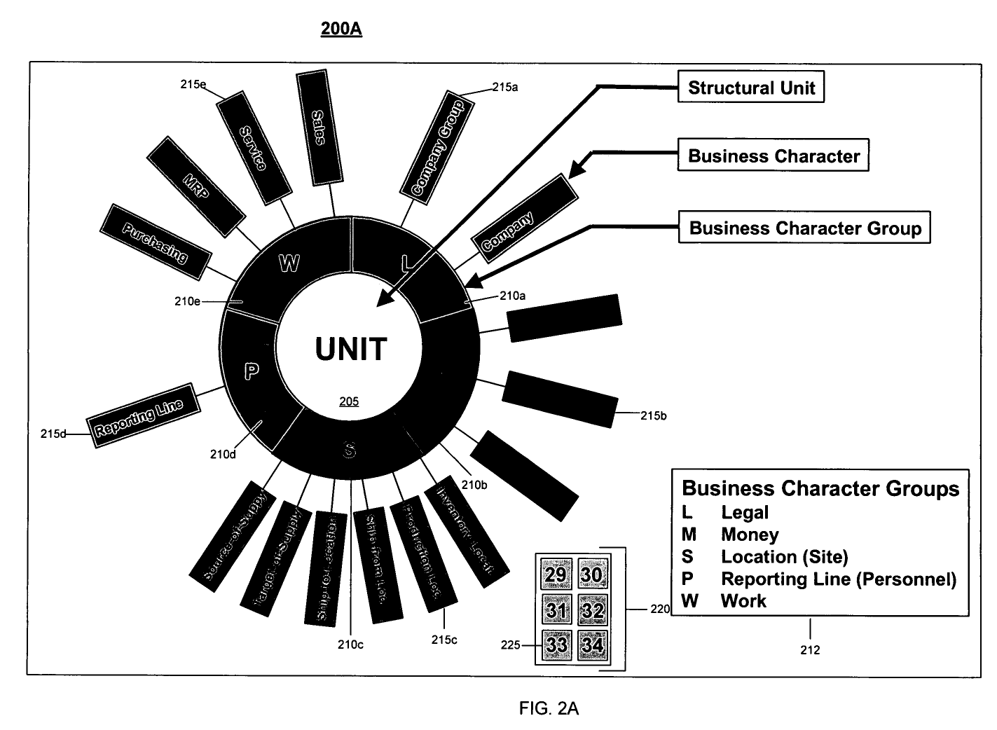

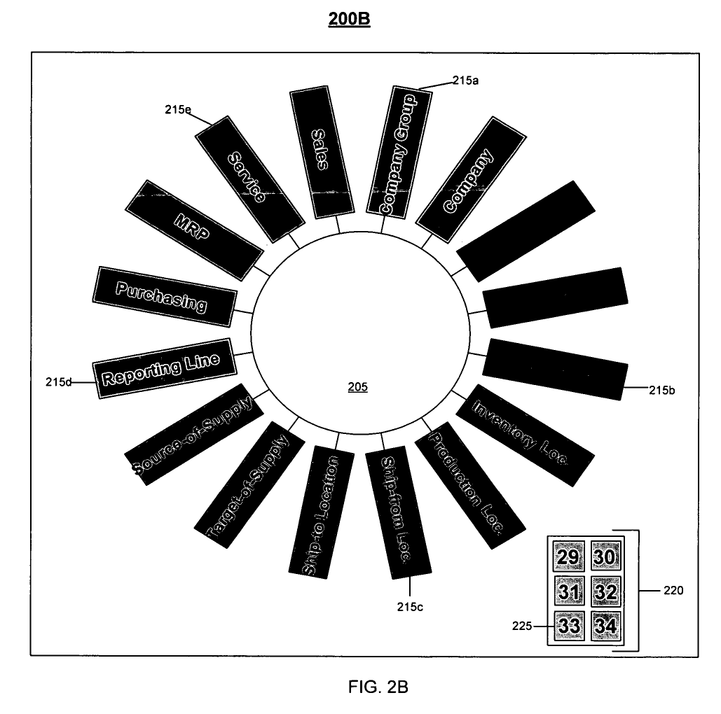

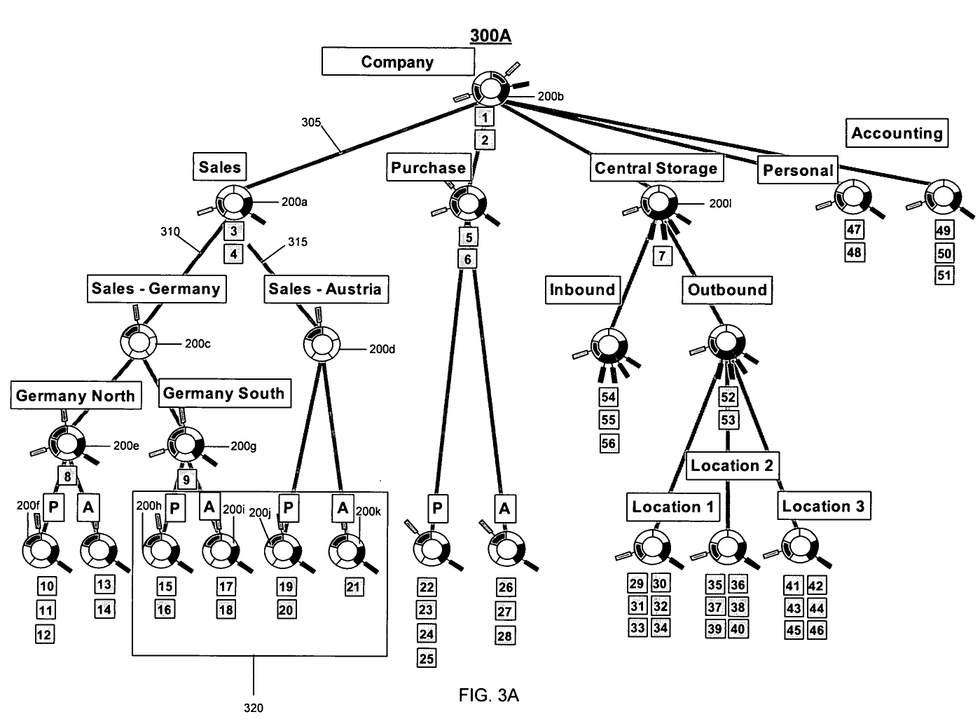

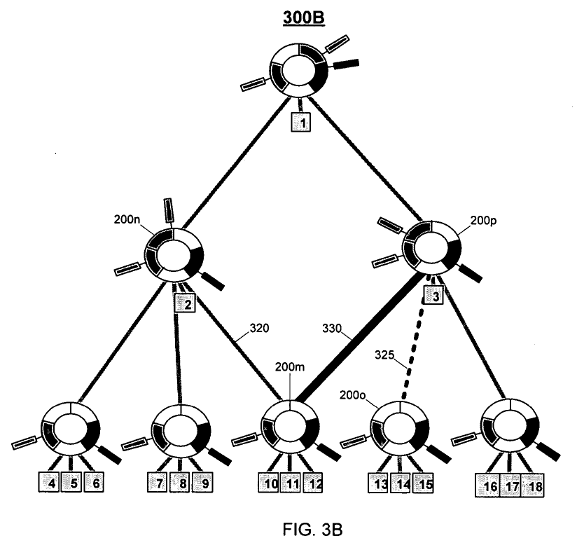

In one implementation, a “position-coded” structural unit indicator is used in which each type of business character is presented in the same display location relative to the display shape used to represent a structural unit indicator. In one example of such a “position-coded” structural unit indicator, when a donut-shape of two concentric circles is used to represent a structural unit indicator, each business characteristic group is assigned a particular portion of the donut-shape, as described more fully later. In another example, a color-coded structural unit indicator may be used in which each business character group displayed in a particular color, such as orange to indicate that the structural unit includes a legal characteristic, red to indicate that the structural unit includes a financial characteristic, blue to indicate that the structural unit includes a site characteristic or a location characteristic, magenta to indicate that the structural unit includes a reporting-line or a personnel characteristic, and green to indicate that the structural unit structure includes a work characteristic. The use of a color-coded structural unit indicator is also described more fully later. In yet another implementation, a shape-coded display is used in which each business character group is represented by a different graphic shape. By way of example, when a structural unit is represented by a rectangle, different kinds of graphic shapes may be used to show each business character group associated with the structural unit. For example, a circle may be used to show one business character group, a rectangle may be used to show another business character group, a diamond may be used to show yet another business character group, and so on. There may be advantages in combining techniques for displaying structural unit indicators. For example, a visually richer display may more effectively communicate organizational structure information when a structural unit indicator is both position-coded and color-coded, as shown in FIGS. 2A, 2B, 3A, and 3B. Similarly, business characters for each structural unit indicator may be position-coded, color-coded, shape-coded, or a combination of coding schemes may be used.

The instruction set 126 for displaying the overall structure of the organization, or a portion thereof, uses the instruction set 122 to display multiple structural unit data structures 132 included in the data store 130, as well as the relationships between the corresponding structural units specified in the relationship data structures 140. The displays created by the instruction sets 122 and 126 may be shown by the organization management application 110 or by one of the applications 150a and 150b to which the organization management application 110 is connected.

The instruction set 124 for modifying a single structural unit is used to access or create a single structural unit data structure 132 and modify the information specifying the corresponding structural unit, including the business characters of the structural unit, the positions of the structural unit, and the relationships involving the structural unit. The instruction set 124 for modifying a single structural unit may associate a period of time with each structural unit data structure 132 that is modified so that changes made over time to the organizational structure represented by the structural units data structures 132 may be tracked and displayed. In one implementation, the period of time may be included in the structural unit data structures 132. In another implementation, the instructions 124 may store the periods of time separately from the structural unit data structures 132.

The organization management application 110 may be implemented using, for example, a general-purpose computer capable of responding to and executing instructions in a defined manner, a personal computer, a special-purpose computer, a workstation, a server, a device, a component, or other equipment or some combination thereof capable of responding to and executing instructions. The organization management application 110 may receive instructions from, for example, a software application, a program, a piece of code, a device, a computer, a computer system, or a combination thereof, which independently or collectively direct operations, as described herein. The instructions may be embodied permanently or temporarily in a machine, a component, a piece of equipment, a storage medium, or a propagated signal that is capable of being delivered to the organization management application 110.

The organization management application 110 includes a communications interface (not shown) used to send communications through the network 160. The communications may include, for example, e-mail, audio data, video data, general binary data, or text data (e.g., encoded in American Standard Code for Information Interchange (ASCII) format). The organization management application 110 also may include one or more input devices, such as a keyboard, mouse, stylus, or microphone, as well as one or more output devices, such as a monitor, touch screen, speakers, or a printer.

The organization management application 110 may be accessed by one or more applications 150a and 150b. The applications 150a and 150b may display and specify the organization information included in the organization management application 110. The applications 150a and 150b include instructions 152a and 152b, respectively, that define the behavior of the applications, as well as data 154a, and 154b, respectively, that is used by the applications. The applications may display and specify the organization information included in the organization management application 110. For example, the instructions 152a of the application 150a may signal the application 150a to access the data store 130 through the network 160 and modify the structural unit information 132. As another example, the instructions 152b of the application 150b may signal for execution of the instruction set 126 for displaying the organization structure such that the organization structure may be displayed by the application 150b. The applications 150a and 150b may be directly connected to the organization management application 110, or the applications 150a and 150b may be connected to the organization management application 110 through a network 160. Furthermore, the organization management application 110 and the applications 150a and 150b may be implemented on the same or different computer systems.

Like the organization management application 110, the applications 150a and 150b may be implemented on, for example, a general-purpose computer capable of responding to and executing instructions in a defined manner, a personal computer, a special-purpose computer, a workstation, a server, a device, a component, or other equipment or some combination thereof capable of responding to and executing instructions. Each of the applications 150a and 150b may be, for example, a software application, a program, a piece of code, a device, a computer, a computer system, or a combination thereof, which independently or collectively direct operations, as described herein. The instructions may be embodied permanently or temporarily in a machine, a component, a piece of equipment, a storage medium, or a propagated signal that is capable of being delivered to the applications 150a and 150b. The applications 150a and 150b also may receive input from one or more input devices, such as a keyboard, mouse, stylus, or microphone, and send output to one or more output devices, such as a monitor, touch screen, speakers, or a printer.

The network 160 typically includes a series of portals interconnected through a coherent system. Examples of the network 160 include the Internet, Wide Area Networks (WANs), Local Area Networks (LANs), analog or digital wired and wireless telephone networks (e.g. a Public Switched Telephone Network (PSTN)), an Integrated Services Digital Network (ISDN), or a Digital Subscriber Line (DSL)), or any other wired or wireless network. The network 120 may include multiple networks or sub-networks, each of which may include, for example, a wired or wireless data pathway. The organization management application 110 is connected to the network 160 through various communication media, such as a modem connected to a telephone line (using, for example, serial line internet protocol (SLIP) or point-to-point protocol (PPP)) or a direct network connection (using, for example, transmission control protocol/internet.

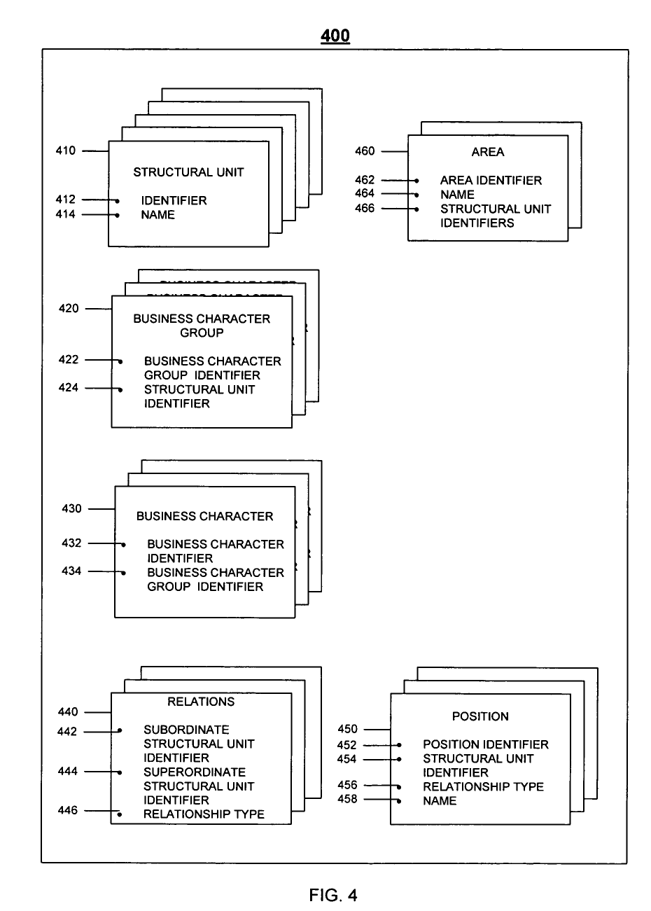

FIG. 2A shows a graphical structural unit indicator 200A that represents one of the structural units included in an organization. The appearance of the graphical structural unit indicator 200A is governed by the definition a structural unit in, for example, one of the structural unit data structures 132 of FIG. 1 or one of the structural unit data structures 410 of FIG. 4. The graphical structural unit indicator 200A is produced as a result of the execution of instructions for displaying a structural unit, such as the instruction set 122 of FIG. 1.

The graphical structural unit indicator 200A generally appears to be a circular structure 205 with multiple spokes extending radially outward from the circular structure 205. The circular structure 205 is divided into multiple business character group indicators 210a-210e. The circular structure 205 includes one of the business character group indicators 210a-210e for each of the business character groups included in the structural unit for which the graphical structural unit indicator 200A is displayed. As indicated by the legend 212, the business character group indicator 210a, labeled “L,” corresponds to the business character group for business characters related to the legal aspects of the structural unit. The business character group indicator 210b, labeled “M,” corresponds to the business character group for business characters related to the financial aspects of the structural unit. The business character group indicator 210c, labeled “S,” corresponds to the business character group for business characters related to the location of the structural unit. The business character group indicator 210d, labeled “P,” corresponds to the business character group for business characters related to the personnel of the structural unit. The business character group indicator 210e, labeled “W,” corresponds to the business character group for business characters related to the work performed at the structural unit. Such business character groups are examples of business character groups to which business characters of a particular structural unit may belong. As would be recognized by one skilled in the art, a business character may be associated with other business character groups, which may be displayed on a graphical structural unit indicator. In some implementations, one or more business characters need not necessarily be associated with any business character group, as described more fully below.

Extending out from the various business character group indicators 210a-210e are business character indicators that correspond to business characters of the structural unit for which the graphical structural unit indicator 200A is displayed. The location of a business character indicator around the circular structure 205 is representative of the business character and/or the business character group to which the corresponding business character belongs. More particularly, if a business character indicator touches one of the business character group indicators 210a-210e, then the corresponding business character belongs to the business character group of the touched business character group indicator. The position of business character indicators 215a-215e relative to the business character group indicators 210a-210e enables quick visual association of business characters and business character groups. The overall character of the corresponding structural unit may be quickly determined from the positions of the business character indicators 215a-215e around the circular structure 205.

By way of example, a business character indicator 215a, corresponding to a business character called “Company Group,” touches the business character group indicator 210a corresponding to the business character group for legal business characters, so the business character called “Company Group” belongs in the business character group for legal business characters. A business character indicator 215b, corresponding to a business character called “Profit Center,” touches the business character group indicator 210b, so the business character called “Profit Center” belongs in the business character group for financial business characters. A business character indicator 215c, corresponding to a business character called “Production Location,” touches the business character group indicator 210c, so the business character called “Production Location” belongs in the business character group for business characters related to the location of the structural unit. A business character indicator 215d, corresponding to a business character called “Reporting Line,” touches the business character group indicator 210d, so the business character called “Reporting Line” belongs in the business character group for business characters related to the personnel of the structural unit. Finally, a business character indicator 215e, corresponding to a business character called “Service,” touches the business character group indicator 210e, so the business character called “Service” belongs in the business character group for business characters related to the work performed at the structural unit.

The business characters illustrated in the graphical structural unit indicator 200A are examples of business characters. Other business characters may be used. In one example, a “shipping location” that represents a shipping location that both receives and sends products may be used as a business character.

The graphical structural unit indicator 200A optionally includes a position indicator 220 that indicates the positions of the structural unit for which the graphical structural unit indicator 200A is displayed. The position indicator 220 includes a box 225 for each of the positions. The box 225 includes a name or an identifier for the corresponding position.

In one implementation, each of the business character group indicators 210a-210e is a particular color, and the business character indicators 215a-215e are the same color as the business character group indicators 210a-210e that the business character indicators 215a-215e touch. The use of similar colors for the various business character group indicators 210a-210e and the business character indicators 215a-215e enables quick visual association of business characters and business character groups. The overall character of the corresponding structural unit may be quickly determined from the colors included in the graphical structural unit indicator 200A.

In another implementation, including implementations where the graphical structural unit indicator 200A is to be printed, varying levels of gray scale may be used to distinguish between the different business character group indicators 210a-210e. In other implementations, different shapes within the circular structure 205 or some other base structure for the graphical structural unit indicator 200A may be used to distinguish between the different business character group indicators 210a-210e. For example, a square may be used for the legal business character group indicator 210a, and a circle may be used for the financial business group indicator 210b.

FIG. 2B also shows a graphical structural unit indicator 200B that represents one of the structural units included in an organization. Like the graphical structural unit indicator 200A of FIG. 2A, the graphical structural unit indicator 200B generally appears to be a circular structure 205 with multiple spokes extending radially outward from the circular structure 205. Each of the spokes extending from the circular structure is a business character indicator that represents a business character of the structural unit for which the graphical structural unit indicator 200B is displayed. However, the circular structure 205 is not divided into multiple business character group indicators, as is the case for the graphical structural unit indicator 200A. Instead, the business character indicators, such as the business character indicators 215a-215e, extend directly out from and are evenly spaced around the circular structure 205 and are not associated with a business character group. Although a business character group may be used as a manner of associating, organizing or grouping business characters, the use of a business character group is not necessary.

The business character indicators placed around the circular structure 205 correspond to business characters named “Company Group,” “Company,” “Segment,” “Profit Center,” “Cost Center,” “Inventory Location,” “Production Location,” “Ship-from Location,” “Ship-To Location,” “Target-of-Supply,” “Source-of-Supply,” “Reporting Line,” “Purchasing,” “MRP,” “Service,” and “Sales.” Such business characters are examples of business characters that may be associated with a particular structural unit. Other business characters may be associated with the structural unit corresponding to the graphical structural unit indicator 200B, and corresponding business character indicators may be displayed in the graphical structural unit indicator 200B.

The graphical structural unit indicator 200B optionally includes a position indicator 220 that is similar to the position indicator 220 of FIG. 2A. The position indicator 220 includes a box 225 for each of the positions of the structural unit for which the graphical structural unit indicator 200B is displayed, and the box 225 includes a name or an identifier for the corresponding position.

In some implementations, the use of a display similar to FIG. 2B may be used to display business characters of a structural unit when the business characters are associated with one or more business character groups. For example, the business group to which a particular business character is associated may be indicated by colors, shading, shape or other manner of showing of the corresponding business character indicator. In other words, the colors, shading or shapes of the business character indicators may be representative of business character groups to which the corresponding business characters belong.

FIG. 3A is an illustration of a hierarchy 300A of graphical structural unit indicators similar to the graphical structural unit indicator 200A of FIG. 2A. Alternatively or additionally, one, some, or all of the graphical structural unit indicators in the hierarchy 300A may be similar to the graphical structural unit indicator 200B of FIG. 2B. Graphical structural unit indicators 200a-200l represent structural units included in an organization, so the hierarchy 300A illustrates the overall structure of the organization. The relative locations of the graphical structural unit indicators within the hierarchy 300A indicate the relationships between the corresponding structural units. More particularly, a first structural unit is subordinate to a second structural unit when the graphical structural unit indicator for the first structural unit appears below the graphical structural unit indicator for the second structural unit in the hierarchy 300A.

The hierarchy 300A includes multiple graphical structural unit indicators that are connected by connectors. The connectors connect a subordinate graphical structural unit indicator with a superordinate graphical structural unit indicator to illustrate the direct relationship between the structural unit of the organization represented by the subordinate graphical structural unit indicator and the structural unit represented by the superordinate graphical structural unit indicator. In one implementation, the direct relationships indicated by the connectors all are of a single type. The relationship may be a legal relationship in which the subordinate structural unit is a legal entity of the superordinate structural unit. The relationship may be a financial relationship in which the subordinate structural unit has a financial obligation to the superordinate structural unit. The relationship may be a working relationship in which the subordinate structural unit performs work for the superordinate structural unit. The relationship may be a personnel relationship in which personnel of the subordinate structural unit are related to personnel of the superordinate structural unit. The relationship may be relationship in the location of the structural units in which the subordinate structural unit and the superordinate structural unit are located in the same place. The structural units also may be related by a standard hierarchical relationship in which the type of the relationship is not specified. Such relationship types are examples of relationships between two structural units, and other types of relationships between structural units may be displayed in the hierarchy 300A. Furthermore, different numbers of relationship types may be used by different organizations. For example, a large organization may use a larger number of relationship types than a small organization. The types of relationships used by an organization may be specified by the organization depending on the needs of the organization.

For example, the graphical structural unit indicator 200a is connected with the graphical structural unit indicator 200b with a connector 305. The connector 305 indicates that the structural units represented by the graphical structural unit indicators 200a and 200b are related. The structural unit represented by the graphical structural unit indicator 200a is subordinate to the structural unit represented by the graphical structural unit indicator 200b, which is the root of the hierarchy 300A. However, the structural unit corresponding to the graphical structural unit indicator 200a is the superordinate member of relationships with the structural units represented by the graphical structural unit indicators 200c and 200d. The graphical structural unit indicators 200a and 200c are connected by a connector 310 and the graphical structural unit indicators 200b and 200d are connected by a connector 315. In fact, all of the structural units represented by the graphical structural unit indicators 210c-210k are directly or indirectly subordinate to the structural unit represented by the graphical structural unit indicator 200b.

The hierarchy 300A also includes an area indicator 320, which encircles a group of structural units that collectively form an area. More particularly, the structural units corresponding to the graphical structural unit indicators 200h-200k form an area, as indicated by the area indicator 320. The structural units corresponding to the graphical structural unit indicators 200h-200k may not be otherwise linked through the relationships illustrated by connectors, such as the connectors 305-315. In one implementation, the structural units corresponding to the graphical structural unit indicators 200h-200k are grouped in the area because the structural units achieve a particular purpose using a common strategy. For example, different structural units may be responsible for paying bills, and the different structural units each may pay the bills with different strategies, processes or procedures (collectively, “strategies”). A first strategy for paying bills may be paying the bills as soon as the bills are received, and a second strategy may be paying the bills just before the payment is due. Only the structural units that use the first strategy to pay the bills may be included in the area represented by the area indicator 320, or only the structural units that use the second strategy to pay the bills may be included in the area. As another example, different structural units each may be responsible for collecting payments from customers and may use different dunning procedures, such as sending, at different times based on the invoice age, a dunning letter to remind a late-paying customer that payment is due. In such a case, an area may include structural units that send dunning letters following the same strategy. Alternatively or additionally, an area may include structural units that employ common strategies for achieving multiple purposes.

Alternatively or additionally, the structural units corresponding to the graphical structural unit indicators 200h-200k may be grouped into an area because the structural units share similar business characters. The structural units may share similar business characters because the structural units achieve a particular purpose with a common strategy, and vice versa. For example, the structural units corresponding to the graphical structural unit indicators 200h-200k all have the same business characters, as evidenced by the same arrangement of business character indicators in the graphical structural unit indicators 200h-200k. However, no direct relationships exist between the structural units corresponding to the graphical structural unit indicators 200h-200k. For this reason, the structural units corresponding to the graphical structural unit indicators 200h-200k may be grouped into the area represented by area indicator 320.

The area indicator 320 is a line around the graphical structural unit indicators corresponding to the structural units included in the area. The area indicator 320 around the grouped graphical structural unit indicators may form a geometric shape, such as a rectangle, a circle, or an ellipse. The area indicator also may form an irregular shape to bound the grouped graphical structural unit indicators and to avoid including in the area within the shape boundary any graphical structural unit indicators that do not correspond to structural units included in the area. In some implementations, the area indicator may be an irregular freeform shape that is generally circular or oval, which may be referred to as a lasso.

The hierarchy 300A may include multiple areas, and each area may be represented on the hierarchy 300A as area indicators around a set of graphical structural unit indicators. Each of the multiple areas may correspond to one of multiple strategies for achieving a particular purpose. In such a case, no graphical structural unit indicator is included in more than one area, because each structural unit employs one strategy to achieve the particular purpose. In other words, a graphical structural unit indicator may belong to at most one area of the multiple areas that relate to achieving a particular purpose (such as collecting payments from customers or paying bills).

The attributes of an area indicator, such as the color, shape, thickness, or style (such as, a dashed line, a dotted line, a dashed and dotted line) of the area indicator, may be used to distinguish between the multiple areas. Using the above example, a red area indicator may be used to represent an area whose structural units pay bills immediately after the bills are received, and a blue area indicator may be used to represent an area whose structural units pay bills immediately prior to the date when the payment is due. In addition, a combination of different area indicator attributes may be used to distinguish between the each of the multiple areas for achieving a particular purpose. For example, a combination of a particular color and a particular line style for one area may be used to distinguish a different area having a different combination of a different color and a different line style.

The hierarchy 300A also may include work responsibilities. A work responsibility includes a work responsibility activity and a work responsibility area. The work responsibility activity includes an activity that should be performed, and the work responsibility area includes an area for which the activity should be performed. Typical work responsibility areas include structural units, products, and business partners. By way of example, a foreman of a purchasing team may have a work responsibility. The work responsibility activity of the work responsibility may be serving as foreman. The corresponding work responsibility area may be links to the structural units of the purchasing team.

Constraints may limit the relationships that may exist between two structural units. The constraints may, for example, ensure consistency throughout the organizational hierarchy 300A. An example constraint dictates that a structural unit with a business character that is a cost center must be a legal entity of another structural unit. Other constraints may relate how change in the hierarchy 300A is handled. For example, the constraints may define what happens when a structural unit is deleted from the organization or when a structural unit is fundamentally changed.

Structural units external to the organization also may be included in the hierarchy 300A to display an extended enterprise including the organization. In other words, business partners of the organization may be included in the hierarchy 300A. For example, in the automobile industry, a parts supplier may be a business partner of an automobile manufacturer. The supplier may be included in a display of the organizational structure of the manufacturer because the manufacturer is an integral, though not legal, part of the manufacturer. As another example, a business enterprise may outsource information technology support to a contractor external to the business enterprise. Employees of the external contractor may be given office space within the business enterprise and may be otherwise indistinguishable from employees of the business enterprise. Therefore it is advantageous to include the external contractor in the organizational structure to illustrate the relationship of the employees of the external contractor to the business enterprise.

FIG. 3B is a second illustration of a hierarchy 300B of graphical structural unit indicators similar to the graphical structural unit indicator 200A of FIG. 2A. Alternatively or additionally, one, some, or all of the graphical structural unit indicators in the hierarchy 300B may be similar to the graphical structural unit indicator 200B of FIG. 2B. Connectors of the hierarchy 300B indicate multiple types of relationships between the structural units corresponding to the graphical structural unit indicators of the hierarchy 300B. Attributes of the connectors, such as the color, shape, thickness, or style (such as, a dashed line, a dotted line, a dashed and dotted line) of the connectors, may be used to distinguish between multiple types of relationships. For example, a red connector may be used to indicate a legal relationship between two corresponding structural units, and a blue connector may be used to indicate a financial relationship between two corresponding structural units. As another example, a dashed line may be used to indicate a working relationship, and a dotted line may be used to indicate a personnel relationship. A combination of varying connector attributes may be used to distinguish between the multiple types of relationships. For example, a blue dashed line may indicate a legal relationship, a blue dotted line may indicate a financial relationship, and a red dashed line may indicate a personnel relationship.

Variations of connector attributes also may be used to indicate variations in values of attributes that describe a single type of relationship. The variations in the values may be continuous or discrete, and the corresponding connector attribute variations may be continuous or discrete to represent the variations in the values. For example, line thickness of a connector may be continuously varied to indicate the amount of money exchanged between two corresponding structural units involved in a financial relationship. As another example, discrete variations in connector color may be used to indicate the number of personnel shared between two corresponding structural units involved in a personnel relationship. In addition, some combination of variations of connector attributes may be used to indicate multiple attribute variations of a single type of relationship.

In the hierarchy 300B, graphical structural unit indicators 200m-200p are connected with connectors 320-330 to indicate that the structural units corresponding to the graphical structural unit indicators 200m-200p are involved in relationships with one another. The connector 320 relates the structural unit corresponding to the graphical structural unit indicator 200m to the structural unit corresponding to the graphical structural unit indicator 200n and is depicted as a solid, narrow line. The connector 325 relates the structural unit corresponding to the graphical structural unit indicator 200o to the structural unit corresponding to the graphical structural unit indicator 200p is depicted as a dashed line. The connectors 320 and 325 are depicted using different attributes to indicate that types of the relationships corresponding to the connectors 320 and 325 are different. For example, the solid line of the connector 320 may indicate that the relationship corresponding to the connector 320 is a financial relationship, whereas the dashed line of the connector 325 may indicate that the relationship corresponding to the connector 325 is a legal relationship.

The connector 330 relates the structural unit corresponding to the graphical structural unit indicator 200m to the structural unit corresponding to the graphical structural unit indicator 200p and is depicted as a solid, thick line. The connectors 325 and 330 are depicted using connectors of different thickness and using the same color (here, black). The shared attributed (here, the color black) may indicate that each of the connectors 325 and 330 represent a common type of relationship. The different attribute (here, the different thickness of the line) may indicate that one or more attributes of the common type of relationship are different. For example, the relationship corresponding to both of the connectors 325 and 330 may be a financial relationship, and the difference in thickness may indicate a difference in the amount of money exchanged between the corresponding structural units. More particularly, the thickness of the connector 330 may indicate that more money is exchanged between the structural units corresponding to the connector 330 than is exchanged between the structural units corresponding to the connector 325 that is depicted as a thinner, dotted line.

FIG. 4 is a block diagram illustrating an example data structure 400 for use in specifying and displaying the hierarchy 300A of FIG. 3A. The data structure 400 stores information describing the organizational structure of an organization. The information stored in the data structure 400 is similar to the data store 130 stored by the organization management application 110, both of FIG. 1. The data structure includes one structural unit data structure 410 for each structural unit of the organization. Each structural unit data structure 410 includes an identifier 412 and a name 414. The identifier 412 is an identifier by which the structural unit information 410 may be referenced and accessed. More particularly, information included in the data structure 400 defining the business characters, business character groups, relationships, positions, and areas associated with the structural unit represented by the structural unit data structure 410 is associated with the structural unit data structure 410 and the corresponding structural unit with the identifier 412. The name 414 is a string that is used to identify the structural unit when the information included in the structural unit data structure 410 is displayed. The name 414 also is an alternate means of reference and access for the structural unit data structure 410.

The data structure 400 also includes one business character group data structure 420 for each business character group for each structural unit for which a structural unit data structure 410 is stored. Each business character group data structure 420 includes a business character group identifier 422 and a structural unit identifier 424. The business character group identifier 422 is an identifier by which the business character group 420 may be referenced and accessed. The structural unit identifier 424 is an identifier of a structural unit data structure 410 to which the business character group data structure 420 corresponds.

The data structure 400 also includes one business character data structure 430 for each business character of each of the structural units of the organization. A business character data structure 430 includes a business character identifier 432 and a business character group identifier 434. The business character identifier 432 is an identifier by which the business character data structure 430 may be referenced and accessed. The business character group identifier 434 is an identifier of the business character group data structure 420 to which the business character data structure 430 corresponds. The business character data structure 430 therefore indirectly corresponds to the structural unit data structure 410 whose identifier is stored in the structural unit identifier 424 of the business character group data structure 420 whose identifier is stored in the business character group identifier 434.

The data structure 400 includes a relation data structure 440 for each of the relationships between the structural units defined in the structural unit data structures 410. Each relation data structure 440 includes two structural unit identifiers 442 and 444 of the structural units that are involved in the relationship specified by the relation data structure 440. When a hierarchical relationship is being specified in the relation data structure 440, the structural unit identifier 442 is an identifier of the subordinate member of the relationship and the structural unit identifier 444 is an identifier of the superordinate member of the relationship. The relation data structure 440 also includes a relationship type 446 that defines the type of relationship between the structural units identified by the structural unit identifiers 442 and 444. In one implementation, the relationship type 446 specifies whether the relationship specified in the relation data structure 440 is a hierarchical relationship, a legal relationship, a financial relationship, a working relationship, a personnel relationship, or a relationship in the location of the structural units.

Each of the structural units may have associated positions, or planned or existing employees or agents of the structural unit. The data structure 400 includes a position data structure 450 for each of the positions included in the organization. The position data structure 450 includes a position identifier 452, a structural unit identifier 454, a relationship type 456, and a name 458. The position identifier 452 is an identifier by which the position data structure 450 may be referenced and accessed. The structural unit identifier 454 is an identifier of the structural unit data structure 410 of the structural unit to which the position specified by the position data structure 450 corresponds. The relationship type 456 identifies whether the position specified by the position data structure 450 has a “work for” relationship with the structural unit corresponding to the structural unit identifier 454 or has a “report to” relationship with another position corresponding to the structural unit. The name 458 is a string, such as “Manager,” that may be used to reference or access the position data structure 450.

The organization may include one or more areas of structural units that are not directly related by the relationships specified by the relation data structures 440. The data structure 400 includes an area data structure 460 for each of the areas in the organization. Each area data structure 460 includes an area identifier 462, a name 464, and structural unit identifiers 466. The area identifier 462 is an identifier by which the area may be referenced and accessed. The name 424 is a string that is used to identify the corresponding area when the information included in the area data structure 460 is displayed. The structural unit identifiers 466 are the identifiers of the structural unit data structures 410 of the structural units included in the area corresponding to the area data structure 460.

The business characters and the business character groups specified by the business character data structures 430 and the business character group data structures 420 may have names by which the appropriate data structures 420 and 430 may be referenced. Consequently, the data structure 400 may include an optional names data structure that associates names of business characters and business character groups with identifiers of corresponding business character data structures 430 and business character group data structures 420. The names data structure enables the reference of the data structures 420 and 430 without the corresponding identifiers. Having an additional data structure specifying the names of business character groups and business characters may be especially important when the business character groups and business characters are definable by a user that may have difficulty remembering abstract identifiers.

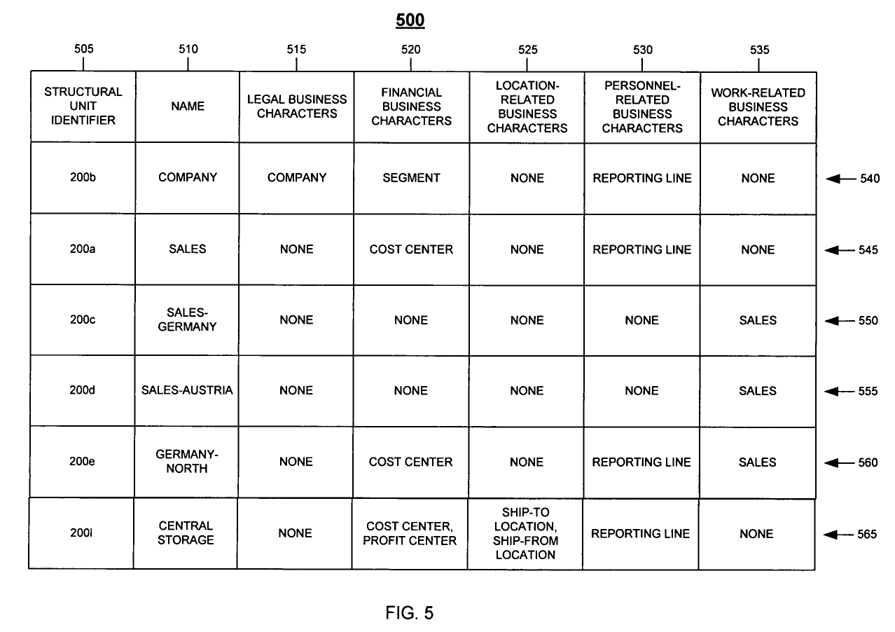

FIG. 5 represents a sample 500 of structural unit information that is stored within the data structure 400 of FIG. 4. More particularly, the information included in the sample 500 is stored in multiple structural unit data structures 410, business character group data structures 420 and business character data structures 430 within the data structure 400. The sample 500 is stored in the data store of an organization management application, such as the data store 130 included in the organization management application 110 of FIG. 1. The information included in the sample 500 is arranged into a series of columns 505-535 and rows 540-565. Each of the columns 505-535 defines an attribute of a structural unit for which information is stored. Each of the rows 540-565 represents a collection of information that defines a structural unit. The attributes include a structural unit identifier 505, a name 510, legal business characters 515, financial business characters 520, location-related business characters 525, personnel-related business characters 530, and work-related business characters 535. The attributes in columns 515-535 define the business character groups included in the structural units defined in the rows 540-565, and the values of the attributes in columns 515-535 are the business characters belonging to the corresponding business character groups.

For example, the row 540 of the sample 500 defines a structural unit with an identifier “200b” and a name of “Company”. The structural unit defined in the row 540 corresponds to the graphical structural unit indicator 200b of FIG. 3A. The structural unit includes a legal business character named “Company,” a financial business character named “Segment,” and a personnel-related business character named “Reporting Line.” As another example, the row 545 defines structural unit with an identifier of “200a” and a name of “Sales” that corresponds to the graphical structural unit indicator 200a of FIG. 3A. The structural unit in row 545 includes a financial business character named “Cost Center” and a personnel-related business character named “Reporting Line.” Any number of business characters may belong to one of the business character groups, as is shown in the row 565, which corresponds to the graphical structural unit indicator 2001 of FIG. 3A. In particular, location-related business characters 525 for row 565 include two business characters (here, a ship-to location and a ship-from location). Financial business characters 520 for row 565 also include two business characters (here, a cost center and a profit center).

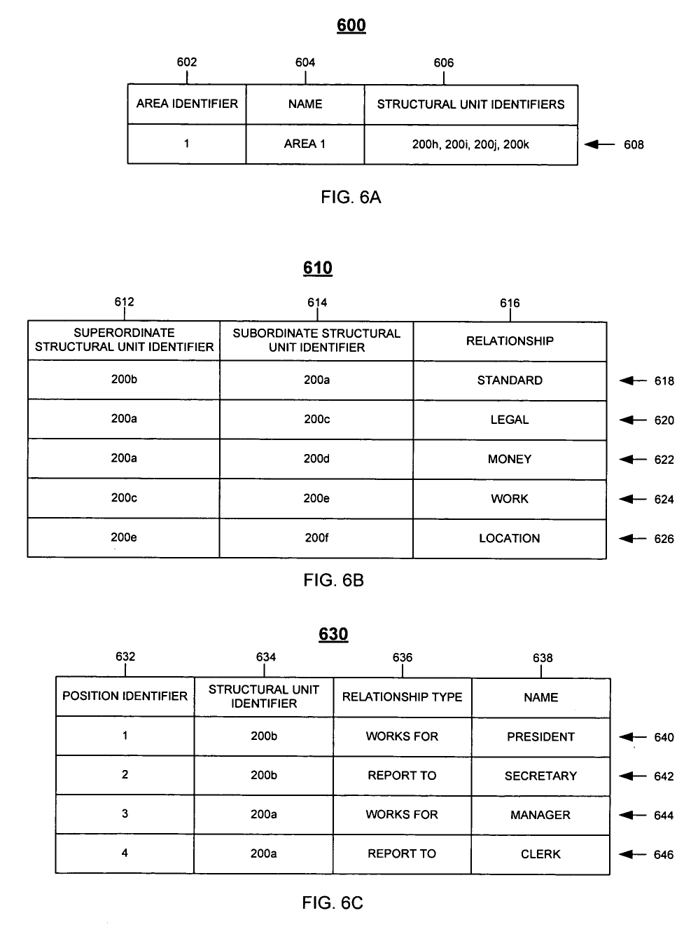

FIG. 6A represents a sample 600 of area information that is stored within the data structure 400 of FIG. 4. More particularly, the area information included in the sample 600 is stored in an area data structure 460 of FIG. 4. The sample 600A is stored in the data store of an organization management application, such as the data store 130 included in the organization management application 110 of FIG. 1. The information included in the sample 600 is arranged into a series of columns 602-606 and a row 608. Each column 602-606 defines an attribute of an area for which the area information is stored. The row 608 represents a collection of information that defines an area. The attributes include an area identifier 602, an area name 604, and structural unit identifiers 606. For example, the row 608 of the sample 600A defines an area with an identifier 320 and a name of “Area 1”. The area defined in the row 608 corresponds to the area 320 of FIG. 3A. The area includes the structural unit identifiers “200h,” “200i,” “200j,” and “200k,” which correspond to the structural units represented by the graphical structural unit indicators 200h-200k of FIG. 3A.

FIG. 6B represents a sample 610 of relationship information that is stored within the data structure 400 of FIG. 4. More particularly, the relationship information included in the sample 610 is stored in multiple relation data structures 440 of FIG. 4. The sample 610 is stored in the data store of an organization management application, such as the data store 130 included in the organization management application 110 of FIG. 1. The information included in the sample 610 is arranged into a series of columns 612-616 and rows 618-626. Each column 612-616 defines an attribute of a relationship for which information is stored. Each row 618-626 represents a collection of information that defines a relationship. The attributes include two structural unit identifiers 612 and 614 and relationship type 616. The structural unit identifiers in the column 612 indicate the superordinate members of the relationships defined in the corresponding rows 618-626. Likewise, the structural unit identifiers in the column 614 indicate the subordinate members of the relationships defined in the corresponding rows 618-626.

For example, the row 618 of the sample 610 defines a relationship between structural units indicated by the identifiers “200b” and “200a” of a standard type. As another example, the row 620 defines a legal relationship between structural units indicated by the identifiers “200a” and “200c.” As yet another example, the row 622 defines a financial relationship between structural units indicated by the identifiers “200a” and “200d.” The identifiers “200a,” “200b,” “200c,” “200d,” “200e,” and “200f” included in the sample 610 correspond to the structural units represented by the graphical structural unit indicators 200a, 200b, 200c, 200d, 200e, 200f, respectively, of FIG. 3A.

FIG. 6C represents a sample 630 of position information that is stored within the data structure 400 of FIG. 4. More particularly, the position information included in the sample 630 is stored in multiple position data structures 450 of FIG. 5. The sample 630 is stored in the data store of an organization management application, such as the data store 130 included in the organization management application 110 of FIG. 1. The information included in the sample 630 is arranged into columns 632 and 634 and rows 636-642. Each of the columns 632 and 634 defines an attribute of a position for which information is stored. Each row 618-626 represents a collection of information that defines a position. The attributes include a position identifier 632 and a structural unit identifier 634, a relationship type 636 and a name 638.

For example, the row 640 of the sample 630 defines a position with an identifier of “1” that corresponds to a structural unit with an identifier of “200b,” which corresponds to the structural unit indicator 200b of FIG. 3A that includes a position with an identifier of “1.” The position defined in the row 640 has a “works for” relationship with the corresponding structural unit and a name of “President.” Similarly, the row 646 defines a position with an identifier of “4” that corresponds to a structural unit with an identifier of “200a,” which corresponds to the structural unit indicator 200a of FIG. 3A that includes a position with an identifier of “4.” The position defined in the row 646 has a “report to” relationship with another position of the corresponding structural unit and a name of “Clerk.” More particularly, the position defined in the row 646 may report to the position defined in the row 644, which has a name of “Manager.”

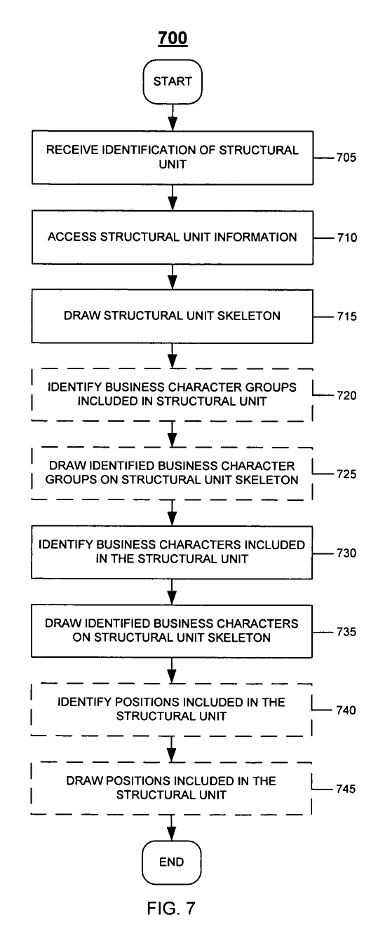

FIG. 7 is a flow chart of a process 700 for displaying a single structural unit as a graphical structural unit indicator, such as the structural unit 200A of FIG. 2A or the structural unit indicator 200B of FIG. 2B. The process 700 is executed by the organization management application 110 of FIG. 1 and is implemented in the organization management application 110 as the instruction set 122 for displaying a single structural unit. The process 700 uses information from the data structure 400 of FIG. 4 to determine how to display the single structural unit. Execution of the process 700 results in the display of a graphical structural unit indicator, such as the graphical structural unit indicator 200A or 200B.

The process 700 begins when the identification of a structural unit is received (step 705). Receiving an identification of the structural unit may include receiving a structural unit identifier, such as the structural unit identifier 412 of FIG. 4. The identification then is used to access the structural unit information (step 710). For example, the identifier 412 may be used to extract the corresponding structural unit data structure 410 from the data structure 400. The organization management application then draws the skeleton of the structural unit (step 715). The structural unit skeleton is the basic shape of the graphical structural unit indicator without any customizations for business character groups, business characters, and positions included in the structural unit. For example, the structural unit skeleton may be the circular structure 205 of FIG. 2A.

When indicators of business character groups are to be displayed on the graphical structural unit indicator, the organization management application identifies the business character groups included in the structural unit (step 720). Identifying the business character groups may include retrieving the business character group data structures 420 whose structural unit identifiers 424 are set to the identifier 412 of the structural unit data structure 410 being displayed. The identified business character groups are drawn onto the structural unit skeleton (step 725). For example, drawing the business character groups onto the structural unit skeleton may include drawing the business character group indicators 210a-210e around the circular structure 205 of FIG. 2A.

The organization management application identifies the business characters included in the structural unit (step 730). Identifying the business characters included in the structural unit may include identifying the business character data structures 430 for which the business character group identifiers 434 is set to the identifier 422 of a previously retrieved business character group data structure 420. The identified business characters are drawn on the structural unit skeleton (step 735). In one implementation, drawing the business characters onto the structural unit skeleton may include drawing the business character indicators onto the graphical structural unit indicator such that each of the business character indicators touches the business character group indicator of the business character group to which the business character corresponding to the business character indicator belongs. In another implementation, drawing the business characters onto the structural unit skeleton may include drawing business character indicators with the same color or shading as the business character group indicator to which the business character indicator corresponds.

The organization management application may identify the positions included in the structural unit (step 740). Identifying the positions included in the structural unit may include identifying the position data structures 450 with a structural unit identifier 454 that matches the structural unit identifier 412 of the structural unit data structure 410 being displayed. The positions that are included in the structural unit being displayed optionally are drawn onto the structural unit skeleton (step 745). Drawing the positions onto the skeleton may include drawing a box for each of the positions near the skeleton and including the identifier of the position in the box.

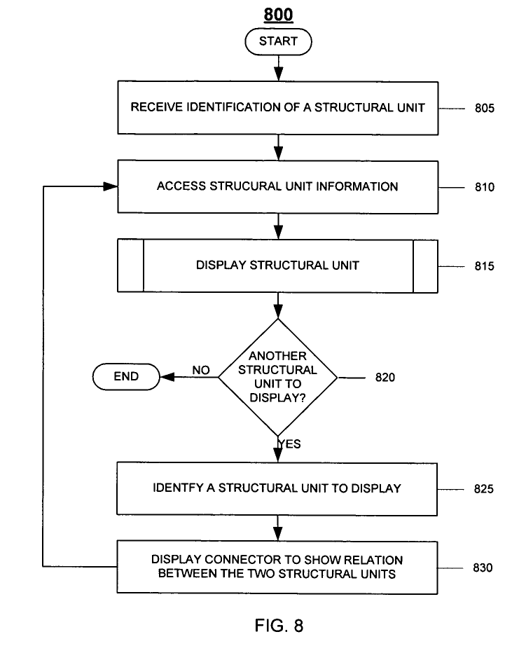

FIG. 8 is a flow chart of a process 800 for displaying the overall structure of an organization. The process 800 is executed by the organization management application 110 of FIG. 1 and is implemented in the organization management application 110 as the instruction set 126 for displaying the organization structure. The process 800 uses information from the data structure 400 of FIG. 4 to determine how to display the organizational structure. Execution of the process 800 may result in the display of an organization hierarchy similar to the hierarchy 300A of FIG. 3A.

The process 800 begins when identification of a structural unit is received (step 805). Receiving an identification of the structural unit may include receiving a structural unit identifier, such as the structural unit identifier 412 of FIG. 4. In one implementation, the structural unit at the top of the organization hierarchy is identified. The identification then is used to access the structural unit information (step 810). For example, the identifier 412 may be used to extract the corresponding structural unit data structure 410 from the data structure 400. The identified structural unit then is displayed (step 815). In other words, a graphical structural unit indicator is displayed for the identified structural unit. In one implementation, the structural unit indicator may be displayed using the process 700 of FIG. 7.

The organization management application whether there is another structural unit to display (step 820). If so, then a structural unit to be displayed is identified (step 825). In one implementation where the structural units define a hierarchy, the structural unit to be displayed may be identified to result in a depth-first traversal and creation of the organizational hierarchy. More particularly, the structural unit to be displayed may be chosen from the set of structural units that are the subordinate member of a relationship involving the identified structural unit that has just been displayed. If no structural units are subordinate to the structural unit that has just been displayed, then a structural unit that is subordinate to a structural unit that is superordinate to the structural unit that has just been displayed is identified. If structural units are identified in this way, then each sub-tree in the organizational hierarchy for which one structural unit indicator has been displayed is completely displayed before any other sub-tree is displayed.

In another implementation, the structural unit to be displayed is identified from the set of structural units that have not been displayed and that have a relationship with the structural unit has just been displayed. If the structural unit that has just been displayed is not involved in any relationships with the remaining structural units that have not been displayed, then any one of the remaining structural units may be identified for display.

When a relationship exists between the structural unit that has just been displayed and the identified structural unit, a connector is displayed to show the relationship between the two structural units (step 830). The displayed connector may be of a particular color or shading to indicate the type of relationship between the two structural units. Information describing the identified structural unit is identified (step 810), and the identified structural unit is displayed (step 815). If another structural unit is to be displayed (step 820), then the structural unit is identified (step 825) and a connector is displayed to illustrate the relationship between the two structural units (step 830). In this manner, all of the structural units and the relationships between the structural units are displayed until the complete structure of the organization has been displayed.

An organization may be include a large number of structural units, and a user may not be able to view and gather information from all of the corresponding structural unit indicators at the same time. For this reason, the user may wish to select and display only a subset of the structural units. In one implementation, the user may first be shown the entire set of structural units. The user may then select the subset of structural units to be displayed, and the subset of structural units is displayed. The user may select the subset of structural units to be displayed by drawing a line around the graphical structural unit indicators to be displayed. Because a smaller number of structural units are included in the subset, the graphical structural unit indicators may be drawn larger than when all structural units were displayed, enabling the user to more easily view the information conveyed by the graphical structural unit indicators.

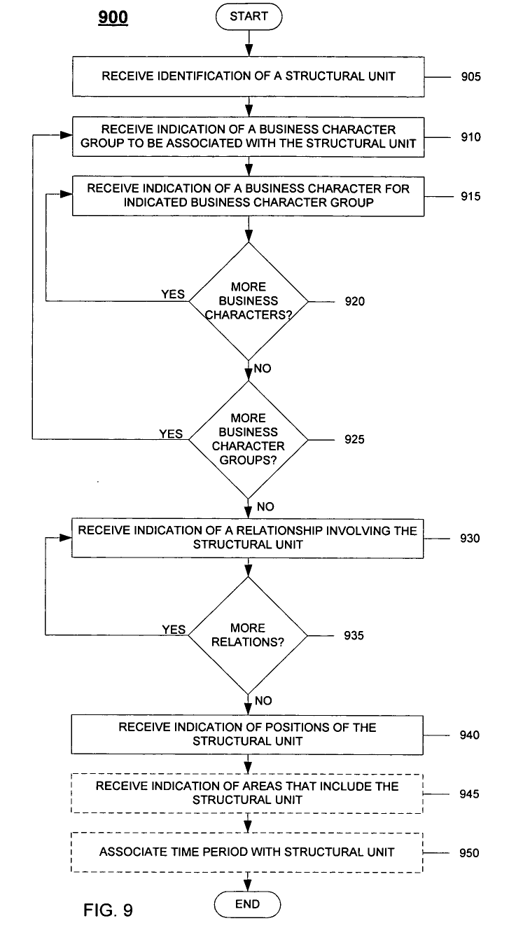

FIG. 9 is a flow chart of a process 900 for specifying the details of a structural unit. The process 900 is executed by the organization management application 110 of FIG. 1 and is implemented in the organization management application 110 as the instruction set 124 for modifying a structural unit. The process 900 specifies or modifies information from the data structure 400 of FIG. 4.

The process 900 begins when identification of a structural unit is received (step 905). Receiving an identification of the structural unit may include receiving a structural unit identifier, such as the structural unit identifier 412 of FIG. 4, of an existing or new structural unit. If the identification points to an existing structural unit data structure 410, then the information included in the structural unit data structure 410 is accessed. If the identification does not point to an existing structural unit data structure 410, then a new structural unit data structure 410 is created with the structural unit identifier 412 set to the received structural unit identifier.

The organization management application then receives an indication of a business character group to be associated with the structural unit (step 910). Receiving an indication of a business character group may include receiving a business character group identifier 422. If the indication points to an existing business character group data structure 420, then the structural unit identifier 424 is set to the previously received structural unit identifier. If the indication does not point to an existing business character group data structure 420, then a new business character group data structure 420 is created with the indication of the business character group set as the identifier 422 of the new business character group data structure 420. The structural unit identifier 424 of the new business character group data structure 420 is set to the previously received structural unit identifier.

The organization management application receives an indication of a business character to be included in the indicated business character group (step 915). In one implementation, receiving an indication of the business character may include receiving a business character identifier 432. If the indication points to an existing business character data structure 430, then the business character group identifier 436 of the business character data structure 430 is set to the business character group identifier 422 of the previously indicated business character group data structure 420. If the indication does not point to an existing business character data structure 430, then a new business character data structure 430 is created with the indication set as the business character identifier 432 of the new business character group structure 430. The business character group identifier 434 of the new business character data structure 430 then is set to the business character group identifier 422 of the previously indicated business character group data structure 420.

The organization management application determines whether more business characters are to be included in the indicated business character group (step 920). If so, then further indications of business characters to be included in the indicated business character group are received (step 915). If not, then the organization management application determines whether more business character groups are to be associated with the structural unit that is being modified or specified (step 925). If so, then indications of business groups to be associated with the structural unit are received (step 910), and indications of the business characters to be included in the indicated business character groups are received (step 915).

After the business character groups and the associated business characters have been specified, then the relationships involving the structural unit may be specified. Specifically, the organization management application receives an indication of a relation involving the structural unit (step 930). The indication of the relation includes an indication of the related structural unit and the type of relationship between the two structural units. In one implementation, the indication of the related structural unit and the relationship type may be used to create a relation data structure 440. More particularly, identifiers of the previously identified structural unit and the related structural unit are stored as the structural unit identifiers 442 and 444, and the received relationship type is stored as the relationship type 446 of the new relation data structure 440. Before the relation data structure 440 is created or modified, the organization management application determines whether the indication relationship is allowed by the relationship constraints associated with the organization structure. If the constrains do not permit then relation data structure 440 is not modified or created. The organization management application determines whether more relations that involve the modified structural unit exist (step 935). If so, then further indications of relations are received (step 930).

After all of the relations have been specified, then an indication of the positions associated with the structural unit, if present, is received. The indication of a position may be a position identifier 452 of a position data structure 450. If the indication of a position points to an existing position data structure 450, then the structural unit identifier 454 of the position data structure is set to the identifier of the structural unit being modified. If the indication does not point to an existing position data structure 450, then a new position data structure 450 is created with the position identifier 452 set to the received indication of a position and with the structural unit identifier 454 set to the identifier of the structural unit being modified. The relationship type 456 and the name 458 for the new position data structure 450 also are specified.

The organization management application optionally may receive indications of areas that include the modified structural unit (step 945). The indication may include an area identifier 462 of an area data structure 460. If the received indication of an area points to an existing area data structure 460, then the identifier of the indicated structural unit is added to the list of structural unit identifiers 466 of the area data structure 460. If the received indication does not point to an existing area data structure 460, then a new area data structure 460 is created with the area identifier 462 set to the received indication of an area and with the identifier of the indicated structural unit added to the list of structural unit identifiers 466. A name 464 for the new area data structure 460 also is specified.

The organization management application optionally may associate a time period with the structural unit being modified (step 950). The time period is associated with the structural unit so that changes to the organizational structure may be tracked and so the evolution of the organizational structure may be displayed. In one implementation, the organizational management application stores the time period in a data structure defining the modified structural unit. In another implementation, the organization management application maintains a separate data structure including information specifying the times at which particular structural units are modified and the modifications made to the particular structural units at those times.

The various indications received by the organization management application during the execution of the process 900 may be generated as a result of user interaction with a display of the organizational structure, such as the hierarchy 300A of FIG. 3A. For example, user selection of a graphical structural unit indicator may create the indication that the structural unit is to be modified. The business character groups, business characters, and positions may be selected from a pallet or menu for inclusion in the selected structural unit. A relationship may be indicated through selection of the graphical structural unit indicators of the two related structural unit and of a type for the relation. Areas may be specified through selection of the structural unit indicators of the structural units to be included in the area. Selecting the structural unit indicators may include drawing a line around the structural unit indicators.

Templates may be created for typical structural units in the organization. The templates may be selected to facilitate the specification information describing the structural units in the organization. The template may include a set of business characters and attributes that all instances of the template are to include. The indication of a structural unit received by the organization management application during the process 900 may be an indication that a new instance of a template is to be created for specifying a new structural unit. More particularly, the indication may be generated as a result of the user selecting a template from a list of possible templates.

As described, the organization management application 110 of FIG. 1 may be a stand-alone application that may be accessed by other applications. The organization management application 110 also may be a module within the other applications.

The methods and techniques described herein are applied to defining and displaying the organizational structure of a business enterprise. However, the methods and techniques may be applied to define and display the organizational structure of any type of organization. For example, the organizational structure of a non-profit charity or a government entity may be defined and displayed with the methods and techniques described herein. In such a case, instead of associating business characters with each component of the organization, other characteristics, attributes, or properties of the components of the organization or functions performed by the corresponding components of the organization may be associated with the components. The characteristics, attributes, properties, and functions of the components may be categorized into multiple groups. In addition, a graphical structural unit indicator also may be referred to as a structural unit indicator.

The techniques can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in various forms of programming languages, including compiled or interpreted languages, and it can be deployed in various forms, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques can be performed by one or more programmable processors executing a computer program to perform functions of the techniques by operating on input data and generating output. Method steps can also be performed by, and apparatus of the techniques can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and various of one or more processors of various kinds of digital computer. Generally, a processor will receive instructions and data from a read-only memory or a random access memory or both. A computer includes a processor for executing instructions and one or more memory devices for storing instructions and data. Generally, a computer will also include, or be operatively coupled to receive data from or transfer data to, or both, one or more mass storage devices for storing data, such as, magnetic, magneto-optical disks, or optical disks. Information carriers suitable for embodying computer program instructions and data include all forms of non-volatile memory, including by way of example semiconductor memory devices, such as, EPROM, EEPROM, and flash memory devices; magnetic disks, such as, internal hard disks or removable disks; magneto-optical disks; and CD-ROM and DVD-ROM disks. The processor and the memory can be supplemented by, or incorporated in special purpose logic circuitry.

Although the techniques and concepts are described using certain sub-processes, the techniques and concepts may be applicable to other types of sub-processes. A number of implementations of the techniques have been described. Nevertheless, it will be understood that various modifications may be made. Accordingly, other implementations are within the scope of the following claims.

1. A computer program product tangibly embodied in an information carrier, the computer program product including instructions that, when executed, generates a graphical user interface on a display device of a computer, the graphical user interface comprising a display for organizational structure information associated with a business organization having multiple organizational units, the organizational structure information including:
structural unit indicators, each structural unit indicator 1) represents a structural unit of the business organization and 2) includes one or more business character indicators, each business character indicator represents one of multiple business characters; and
connectors, each connector is associated with two and only two structural unit indicators and represents a hierarchical relationship between the two structural unit indicators, one of the structural unit indicators corresponding to a subordinate structural unit and another of the structural unit indicators corresponding to a superordinate structural unit,
wherein display position of each type of the business character indicator is substantially the same display position relative to 1) shape of the structural unit indicators and 2) others of the multiple business characters.

2. The computer program product of claim 1 wherein at least one of the structural unit indicators includes one or more position indicators, each position indicator identifying a position that is associated with the structural unit represented by the structural unit indicator.

3. The computer program product of claim 1 wherein a display attribute of each business character indicator of a particular business character is substantially the same as display attributes of other business character indicators of the particular business character.

4. The computer program product of claim 3 wherein the display attribute comprises one or more of a shape, a color, or a type of shading.

5. The computer program product of claim 1 wherein a display attribute of each business character indicator of a particular business character indicates an association of the particular business character with a business character group.

6. The computer program product of claim 5 wherein the display attribute comprises one or more of a shape, a color, or a type of shading.

7. The computer program product of claim 1 wherein a business character indicator represents one of the business characters company, company group, segment, profit center, cost center, inventory location, production location, ship-from location, ship-to location, target-of-supply, source-of-supply, purchasing, service, and sales.

8. The computer program product of claim 1 wherein at least one of the structural unit indicators includes an indicator of a business character group that 1) is associated with the structural unit represented by the at least one structural unit indicator and 2) is associated with one or more business characters represented by business character indicators included in the at least one structural unit indicator.

9. The computer program product of claim 8 wherein a display attribute of the indicator of the business character group is substantially the same as a display attribute of the one or more business character indicators associated with the indicator of the business character group.

10. The computer program product of claim 1 wherein each of the structural unit indicators includes an indicator of a business character group that 1) is associated with the structural unit represented by the structural unit indicator and 2) is associated with one or more business characters represented by business character indicators included in the structural unit indicator.

11. The computer program product of claim 10 wherein a display attribute of the indicator of the business character group is substantially the same as a display attribute of the one or more business character indicators associated with the indicator of the business character group.

12. The computer program product of claim 1 wherein the organizational structure information includes:
external structural unit indicators, each external structural unit indicator (1) representing a structural unit external to the business organization that is included in an extended enterprise of the business organization and (2) including one or more business character indicators being associated with the external structural unit; and
external connectors, each connector being associated with at least one graphical external structural unit indicators and representing a hierarchical relationship between the at least one external structural unit indicator and a structural unit indicator or between two external structural unit indicators, one of the structural unit indicators corresponding to a subordinate structural unit and another of the structural unit indicator corresponding to a superordinate structural unit,
wherein the display position of each of the business character indicators is substantially the same display position relative to a shape of the structural unit indicator.

13. A method for presenting a graphical user interface that displays organizational structure information associated with a business organization having multiple organizational units on a display device of a computer, the method comprising:
displaying structural unit indicators, each structural unit indicator 1) represents a structural unit of the business organization and 2) includes one or more business character indicators, each business character indicator represents one of multiple business characters; and
displaying connectors, each connector is associated with two and only two structural unit indicators and represents a hierarchical relationship between the two structural unit indicators, one of the structural unit indicators corresponding to a subordinate structural unit and another of the structural unit indicators corresponding to a superordinate structural unit,
wherein display position of each type of the business character indicator is substantially the same display position relative to 1) shape of the structural unit indicators and 2) others of the multiple business characters.

14. The method of claim 13 wherein at least one of the structural unit indicators includes one or more position indicators, each position indicator identifying a position that is associated with the structural unit represented by the structural unit indicator.

15. The method of claim 13 wherein a display attribute of each business character indicator of a particular business character is substantially the same as display attributes of other business character indicators of the particular business character.

16. The method of claim 15 wherein the display attribute comprises one or more of a shape, a color, or a type of shading.

17. The method of claim 13 wherein a display attribute of each business character indicator of a particular business character indicates an association of the particular business character with a business character group.

18. The method of claim 17 wherein the display attribute comprises one or more of a shape, a color, or a type of shading.

19. The method of claim 13 wherein a business character indicator represents one of the business characters company, company group, segment, profit center, cost center, inventory location, production location, ship-from location, ship-to location, target-of-supply, source-of-supply, purchasing, service, and sales.

20. The method of claim 13 wherein at least one of the structural unit indicators includes an indicator of a business character group that 1) is associated with the structural unit represented by the at least one structural unit indicator and 2) is associated with one or more business characters represented by business character indicators included in the at least one structural unit indicator.

21. The method of claim 20 wherein a display attribute of the indicator of the business character group is substantially the same as a display attribute of the one or more business character indicators associated with the indicator of the business character group.

22. The method of claim 13 wherein the organizational structure information includes:
external structural unit indicators, each external structural unit indicator (1) representing a structural unit external to the business organization that is included in an extended enterprise of the business organization and (2) including one or more business character indicators being associated with the external structural unit; and
external connectors, each connector being associated with at least one graphical external structural unit indicators and representing a hierarchical relationship between the at least one external structural unit indicator and a structural unit indicator or between two external structural unit indicators, one of the structural unit indicators corresponding to a subordinate structural unit and another of the structural unit indicator corresponding to a superordinate structural unit,
wherein the display position of each of the business character indicators is substantially the same display position relative to a shape of the structural unit indicator.

23. A computer program product tangibly embodied in an information carrier, the computer program product including instructions that, when executed, generates a graphical user interface on a display device of a computer, the graphical user interface comprising a display for organizational structure information associated with a business organization having multiple organizational units, the organizational structure information including:
structural unit indicators, each structural unit indicator 1) represents a structural unit of the business organization, 2) includes one or more business character indicators, each business character indicator is a rectangular shape that represents one of multiple business characters, and 3) includes a circular structure from which the rectangular shapes of the business character indicators extend radially outward; and
connectors, each connector 1) is associated with two and only two structural unit indicators, 2) represents a hierarchical relationship between the two structural unit indicators, one of the structural unit indicators corresponding to a subordinate structural unit and another of the structural unit indicators corresponding to a superordinate structural unit, and 3) is a line connecting the circular structures of the two structural unit indicators,
wherein display position of each type of the business character indicator is substantially the same display position relative to 1) shape of the structural unit indicators and 2) others of the multiple business characters.

24. The computer program product of claim 23 wherein at least one of the structural unit indicators includes an indicator of a business character group that 1) is associated with the structural unit represented by the at least one structural unit indicator and 2) is associated with one or more business characters represented by business character indicators included in the at least one structural unit indicator, the indicator of the business character group is a section of the circular structure of the at least one structural unit indicator that shares common display attributes with and is located near the business character indicators of the structural unit indicator that represent business characters associated with the business character group.

25. The computer program product of claim 23 wherein:
at least one of the connectors represents a hierarchical relationship of a first hierarchical type,
at least one of the connects represents a hierarchical relationship of a second hierarchical type,
the first hierarchical type differs from the second hierarchical type; and
display attributes of the connector that represents the hierarchical relationship of the first hierarchical type differ from display attributes of the connector that represents the hierarchical relationship of the second hierarchical type.
